(19) United States
(12) Patent Application Publication
(10) Pub. No.: US 2020/0296946 A1
(43) Pub. Date: Sep. 24, 2020

(54) FISHING LURE HAVING IMPROVED FIN CHARACTERISTICS

(71) Applicant: Rabid Baits LLC, Poultney, VT (US)

(72) Inventors: Robert Scott, SR., Poultney, VT (US); Robert Scott, JR., Poultney, VT (US)

(21) Appl. No.: 16/358,990

(22) Filed: Mar. 20, 2019

(51) Int. Cl. A01K 85/08; B29C 39/10

(52) U.S. Cl. CPC A01K 85/08; B29K 2711/00; B29C 39/10

(57) ABSTRACT

A method of manufacturing a fishing lure includes positioning a feather or fur portion about a mold that approximates a body of a fishing lure. The feather or fur portion is positioned proximal to where a fin of the fishing lure would be. The method includes filling the mold with a flexible material to form the fishing lure body, wherein the flexible material engages the feather or fur portion to encapsulate at least a portion thereof within the fishing lure body and ejecting the completed fishing lure body having feather or fur portions at the position proximal to where a fin of the fishing lure would be. A related fishing lure/bait is also provided.

### TECHNICAL FIELD

This application is directed towards a fishing lure having improved fin characteristics, and, more particularly, towards a fishing lure having integrally molded or formed fin portions formed from a natural feather or fur portion.

### BACKGROUND

With ever increasing numbers of ever more skilled fishermen attempting to catch fish in waters that see a lot of fishing pressure, lures need to closely duplicate the look, feel, action and sound of real baitfish in order to fool predatory fish that have seen, and been caught by, numerous lures.

The “Soft Stick-bait” is one trend in fishing lures designed to help overcome the natural and learned cautiousness of predatory fish. Soft Stick-baits are elongated soft plastic lures that imitate the disorientated and erratic movement of a wounded or pursued baitfish. Short, sharp and erratic twitches of the fishing rod tip prompt this erratic movement, often triggering strikes by predatory gamefish.

Soft stick-baits are usually fairly featureless chunks of elongated soft plastic that do not look very much like the baitfish their actions are supposed to duplicate. Furthermore, traditional soft stick-baits may include a dressing or skirt to approximate a fin portion to better appear to be a bait fish, however, the dressing or skirts are less than ideal because the skirts are either externally mounted to the lure, or made of a non-natural material, that the fish senses upon striking and releases before the fisherman can hook the fish.

Accordingly, there remains a need to improve upon traditional bait options.

### SUMMARY

According to one or more embodiments, a method of manufacturing a fishing lure includes positioning a feather or fur portion about a mold that approximates a body of a fishing lure. The feather or fur portion is positioned proximal to where a fin of the fishing lure would be. The method includes filling the mold with a flexible material to form the fishing lure body, wherein the flexible material engages the feather or fur portion to encapsulate at least a portion thereof within the fishing lure body and ejecting the completed fishing lure body having feather or fur portions at the position proximal to where a fin of the fishing lure would be.

According to one or more embodiments, the feather portion is a natural feather portion.

According to one or more embodiments, the fur portion is a natural fur portion.

According to one or more embodiments, the method includes determining where to position the feather or fur portion.

According to one or more embodiments, the flexible material is a polymer.

According to one or more embodiments, the mold defines a cutout for receiving the feather or fur portion.

According to one or more embodiments, the flexible material is translucent.

According to one or more embodiments, the method includes providing a hook portion extending through a cavity of the mold.

### BRIEF DESCRIPTION OF THE DRAWINGS

The previous summary and the following detailed descriptions are to be read in view of the drawings, which illustrate some (but not all) embodiments of the presently disclosed subject matter.

FIG. 1A is a top facing, perspective view of a first portion of a mold assembly according to one or more embodiments disclosed herein;

FIG. 1B is a top facing, perspective view of a second portion of a mold assembly according to one or more embodiments disclosed herein;

FIG. 2 is a top facing, perspective view of the second portion of the mold assembly where a feather or fur portion is positioned within an injection channel;

FIG. 3 is a front facing view of the mold assembly where the mold portions are engaged with the base plate and in engagement with an applicator;

FIG. 4 is a front facing view of the mold assembly where the mold portions are disengaged from the base plate and the lure, and the lure is ejected from the mold assembly;

FIG. 5A is a top view of a lure made with the mold and according to the methods disclosed herein; and

FIG. 5B is a top view of a lure made with the mold and according to the methods disclosed herein, where the lure is shown being pulled by a leader, thus causing movement of the fin portions formed according to one or more embodiments disclosed herein.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

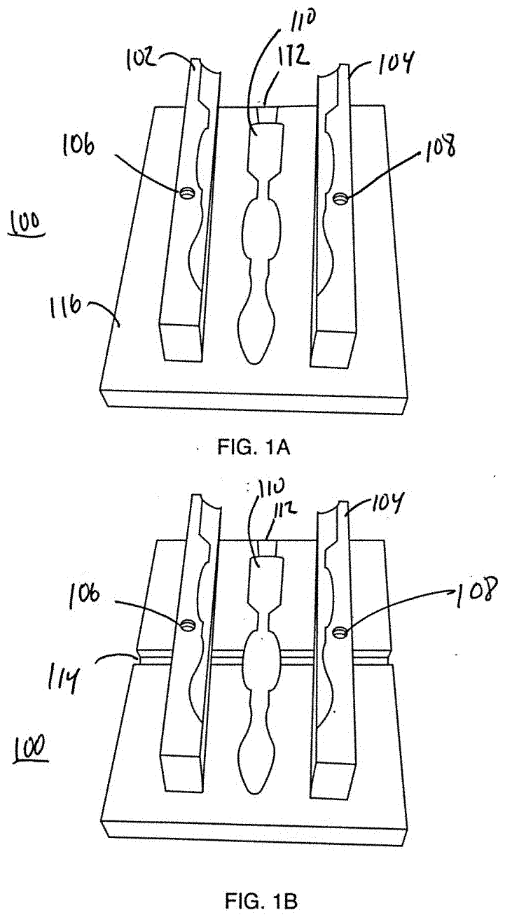

A mold for manufacturing a fishing lure is illustrated in FIGS. 1A and 1B and generally designated 100. The embodiment shown in FIG. 1A does not show a positioning channel, while the embodiment shown in FIG. 1B illustrates the channel. The mold 100 may include a base plate 116. The base plate 116 may further include a recess 110 that approximates a fishing lure body. The recess 110 can be selected among a variety of shapes and sizes. The mold 100 may further include a first mold portion 102 and a second mold portion 104. Mold portions 102 and 104 cooperatively form the lure body with recess 110. The mold portions 102 and 104 are shown turned 90 degrees from an operational position. An aperture 106 and 108 extends through respective mold portions 102 and 104 to engage the portions together. An aperture may extend through each mold portion 102, 104 for engaging the mold portions 102, 104 to the base plate 116. An injector port 112 may be fluidly engaged with recess 110, such that fluids injected into injector port 112 flow into recess 110. The “extra” portion of mold material formed in 112 may be trimmed or otherwise removed after molding is completed.

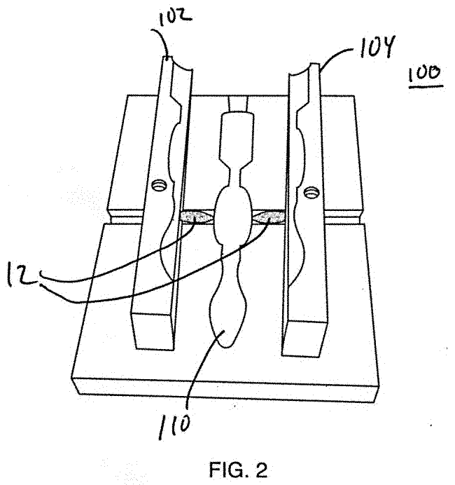

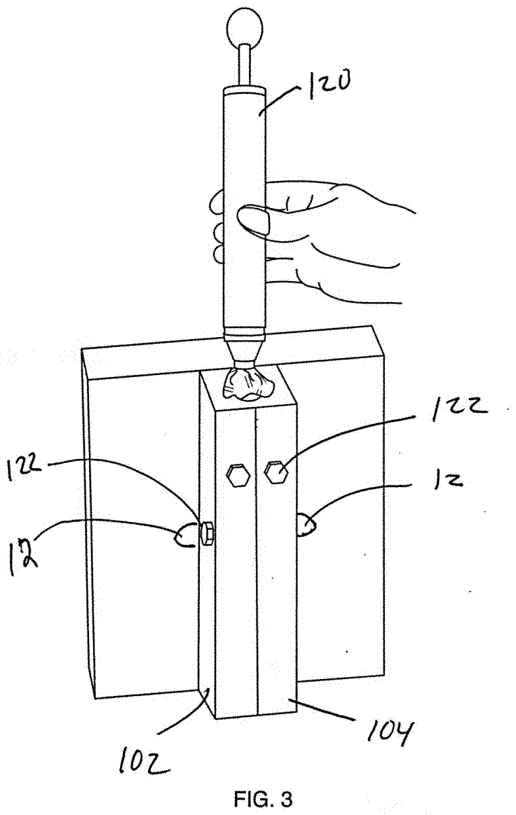

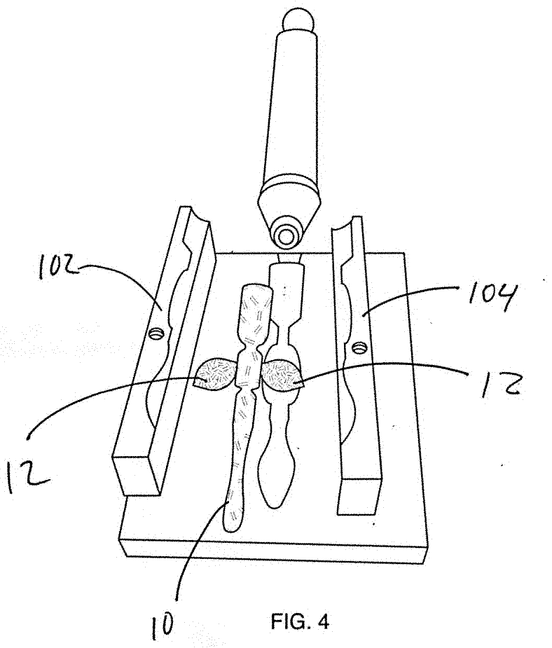

A channel 114 may also be provided into which a fur or feather portion can be inserted before the mold portions 102 and 104 are rotated 90 degrees (relative to the view shown in FIGS. 1A and 1B) such that a face of each mold portions 102, 104 thus engages and sandwiches the feather or fur portion on each side (as is illustrated in FIG. 2). As illustrated in FIG. 3, the feathers or fur portions may extend from mold 100 in the the channel 114. The injector 230 is shown in fluid communication with the injector port 112. In operation, a first injection fluid may be provided into the base plate 116 and a second injection fluid may be injected at a second time in order to create a lure having differing color, texture, reflectivity, and other visual or textural characteristics. As illustrated, a variety of fasteners may couple the mold together.

The mold illustrated in FIGS. 1A, 1B, 2, and 3 is one exemplary embodiment, but many other mold assemblies can be selected and used. Thus, the claimed invention can be formed from molds of many different characteristics.

After the flexible molding material is injected into the mold, the lure 10 is ejected from the mold 100 by removing the mold portions 102, 104 (which may be accomplished via removal of the fasteners). Since the fur or feather portion was positioned within the mold recess 110, when the molding material was injected into the mold recess, at least a portion of the fur or feather was integrally formed within the body of the fishing lure.

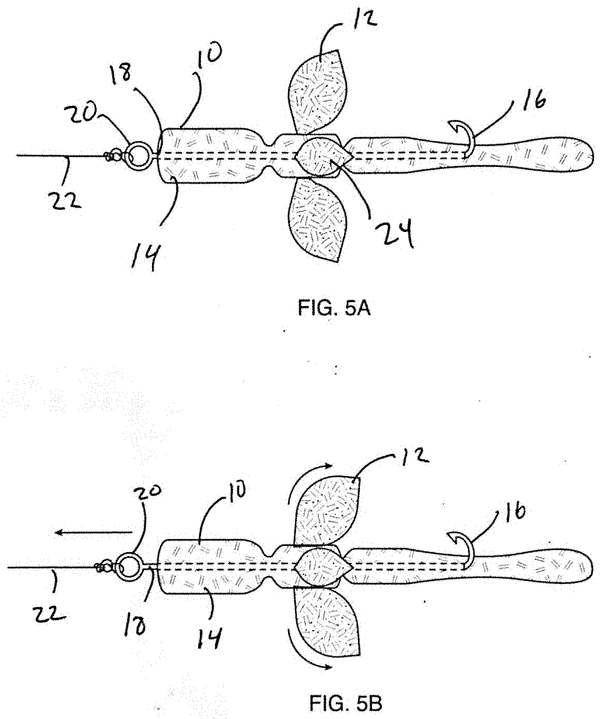

The advantages of the lure 10 disclosed herein are readily illustrated in FIGS. 5A and 5B. As illustrated, lure 10 includes the fin portion 12 made from fur or feather portions 12. The fur and feather portions 12 are thus integrally formed within the lure 10 body and sealed within the injection molding process. By having the fin 12 made from a natural or non-man made material, the fish bite is more natural to the fish during a strike because the material is consistent in texture to a material that the fish may have ingested before. The behaviour of the lure 10 is well-illustrated in FIGS. 5A and 5B. FIG. 5B shows the lure 10 being pulled in the direction of the arrow. The lure 10 may include a head portion 14 through which a shank 18 of a hook 16 extends. Hook 16 may be provided within the molding process, meaning the hook is placed within the recess of the mold, or the hook may be inserted through the soft body thereafter. The hook 16 may include a tying end 20 connected to shank 18, which is tied to a line 22. Because the fish does not detect the plasticity of a fake or imitation lure when they grab onto the fur or feather portion, the fish maintains contact with the lure 10 longer, thus allowing the angler more time to engage the hook 16. This is especially important because the fur or feather portion 12 forming the fin portion is often times the first thing that a fish will taste or feel. A top fin 24 may also be provided as illustrated. The lure is illustrated as a fish, such as a minnow or other bait fish, but a worm or any other appropriately configured lure may be provided.

While the embodiments have been described in connection with the various embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

1. A method of manufacturing a fishing lure comprising:
positioning a feather or fur portion about a mold that approximates a body of a fishing lure, wherein the feather or fur portion is positioned proximal to where a fin of the fishing lure would be;
filling the mold with a flexible material to form the fishing lure body, wherein the flexible material engages the feather or fur portion to encapsulate at least a portion thereof within the fishing lure body;
ejecting the completed fishing lure body having feather or fur portions at the position proximal to where a fin of the fishing lure would be.

2. The method of claim 1, wherein the feather portion is a natural feather portion.

3. The method of claim 1, wherein the fur portion is a natural fur portion.

4. The method of claim 1, further comprising determining where to position the feather or fur portion.

5. The method of claim 1, wherein the flexible material is a polymer.

6. The method of claim 1, wherein the mold defines a cutout for receiving the feather or fur portion.

7. The method of claim 1, wherein the flexible material is translucent.

8. The method of claim 1, further comprising providing a hook portion extending through a cavity of the mold.

9. A fishing lure made according to a process, wherein the process comprises:
positioning a feather or fur portion about a mold that approximates a body of a fishing lure;
filling the mold with a flexible material to form the fishing lure body, wherein the flexible material engages the feather or fur portion to encapsulate at least a portion thereof within the fishing lure body;
ejecting the completed fishing lure body having feather or fur portions at the position proximal to where a fin of the fishing lure would be,
wherein the feather or fur portion is positioned proximal to where a fin of the fishing lure would be such that a fishing lure having a flexible body portion with a feather or fur portion extending therefrom is formed to approximate a shape of the fin of a lure.

10. The process of claim 9, wherein the feather portion is a natural feather portion.

11. The process of claim 9, wherein the fur portion is a natural fur portion.

12. The process of claim 9, further comprising determining where to position the feather or fur portion.

13. The process of claim 9, wherein the flexible material is a polymer.

14. The process of claim 9, wherein the mold defines a cutout for receiving the feather or fur portion.

15. The process of claim 9, wherein the flexible material is translucent.

16. The process of claim 9, further comprising providing a hook portion extending through a cavity of the mold.
